(19) United States
(12) Patent Application Publication
(10) Pub. No.: US 2008/0182434 A1
(43) Pub. Date: Jul. 31, 2008

(54) Low Cost Stacked Package

(75) Inventor: Thomas M. Goida, Windham, NH (US)

Correspondence Address: BROMBERG & SUNSTEIN LLP, 125 SUMMER STREET, BOSTON, MA, 02110-1618, US

(73) Assignee: ANALOG DEVICES, INC., Norwood, MA (US)

(21) Appl. No.: 11/627,050

(22) Filed: Jan. 25, 2007

(51) Int. Cl. H01R 12/00; H01R 43/00

(52) U.S. Cl. 439/68; 29/827

(57) ABSTRACT

An electronics package is described in which a quad flat no lead (QFN) electronic package has top and bottom surfaces. The bottom surface includes bottom contact pads arranged in a first pattern for electrical connection to corresponding package contact pads of an underlying circuit structure. The top surface includes top contact pads arranged in a second pattern for electrical connection to corresponding bottom contact pads of an overlying electronic package.

### FIELD OF THE INVENTION

The present invention relates to packages for electronic circuits, and specially, a three-dimensional stackable package.

### BACKGROUND ART

One constraint on the development of new electronic products is the assembly and packaging of the required circuits. The cost of packaging is one major factor and one significant way to lower costs is by increased miniaturization, complexity, and density of device packages.

One popular electronics package currently used is the Quad Flat No-Lead (QFN) package, which includes a chip carrier made of plastic or ceramic with electrical contacts underneath the sides of the package. The die containing the circuits is usually bonded to a leadframe substrate and electrical connections to the top side of the die are made by wirebonding.

Another approach to the challenges of electronics packaging includes stacked three dimensional packaging solutions (known as 3D or Z-axis). Current stacked package technology utilizes Ball Grid Array (BGA) technology in which conductive balls (e.g., solder) on the underside of the package are used to directly mount the package to the underlying circuit board. But, BGA technology is relatively expensive. QFN technology does not presently offer stacked packaging solutions, but it is well accepted and low cost.

### SUMMARY OF THE INVENTION

Embodiments of the present invention include a Quad Flat No-Lead (QFN) electronic package having top and bottom surfaces, and a method of producing such a package. The bottom surface includes bottom contact pads arranged in a first pattern for electrical connection to corresponding package contact pads of an underlying circuit structure. The top surface includes top contact pads arranged in a second pattern for electrical connection to corresponding bottom contact pads of an overlying electronic package.

In some specific embodiments, the top contact pads are the tops of leadframe pedestals of a leadframe including the bottom contact pads. In further such embodiments, the leadframe pedestals may have a height greater than the thickness of the leadframe.

In addition or alternatively, the top contact pads may be the tops of filled vias in the package. In such case, the vias may be filled with a solidified flow of electrically conductive material and/or with electrically conductive pins. In some specific embodiments, a set of the top contact pads may be electrically connected to a set of the bottom contact pads.

Embodiments also include a method of creating an electronics package. In one specific such method, a quad flat no lead (QFN) electronic package is fabricated having top and bottom surfaces. The bottom surface includes bottom circuit contacts for electrical connection to corresponding package contacts of an underlying circuit structure, and the top surface includes top circuit contacts for electrical connection to corresponding bottom circuit contacts of an overlying electronic package.

In further specific embodiments, the top circuit contacts are the tops of leadframe pedestals of a leadframe including the bottom circuit contacts. In further such embodiments, the leadframe pedestals may have a height greater than the thickness of the leadframe.

In addition or alternatively, the top circuit contacts may be the tops of filled vias in the package. Such vias may be filled with a solidified flow of electrically conductive material and/or with electrically conductive pins. One or more of the top circuit contacts may be electrically connected to one or more of the bottom circuit contacts.

### BRIEF DESCRIPTION OF THE DRAWINGS

FIG. 1 is an elevated perspective view of a stackable QFN package according to one embodiment of the present invention.

FIGS. 2A-D show various stages in assembling a three dimensional QFN-based package according to an embodiment.

FIG. 3 shows general functional steps in a process for assembling a three dimensional QFN-based package.

FIG. 4 shows a three dimensional QFN-based package according to an embodiment using through package vias.

### DETAILED DESCRIPTION OF SPECIFIC EMBODIMENTS

Various embodiments of the present invention are directed to techniques for a stackable QFN package that provides three dimensional connection functionality.

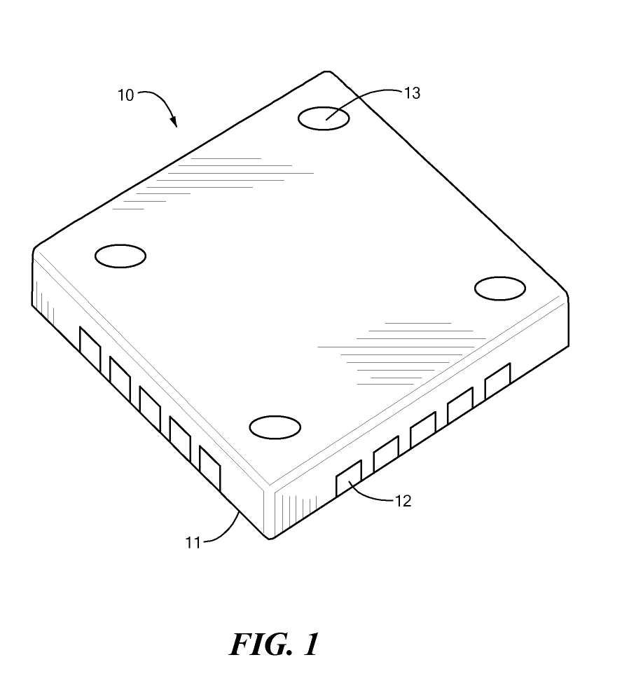

FIG. 1 shows an elevated perspective view of an overmolded, leadframe-type, stackable QFN package 10 according to one specific embodiment of the present invention. The QFN package 10 includes an internal leadframe and attached circuit die which are encased in encapsulating material 11 (e.g., polymeric material, such as a plastic like an insulated thermosetting epoxy resin). The bottom surface includes bottom circuit contacts 12 for electrical connection to corresponding package contacts of an underlying circuit structure. The underlying circuit structure might be a circuit board or another device package. The top surface of the QFN package 10 includes top circuit contacts 13 for electrical connection to an overlying circuit structure such as another device package. Those in the art understand that there are various types and shapes of overmolded packages. For example, the QFN package 10 shown in FIG. 1 is substantially flat and essentially forms a three-dimensional cuboid shape. Other specific embodiments may have other specific shapes and proportions.

The encapsulating material 11 illustratively is a molded material, such as plastic, that is molded in a planar manner to give the QFN package 10 its substantially planar profile. The encapsulating material 11 also maintains electrically isolation between each of the various circuit contacts 12 and 13.

One or more of the various circuit contacts 12 and 13 may provide a circuit common or ground, while other contacts may be set to various different electrical supply potentials or couple one or more circuit signals. Thus, some of the circuit contacts 12 and 13 may receive signal data from an external component and/or transmit signal data to an external component via a coupled circuit board. In some embodiments, various of the top circuit contacts 13 may extend through the body of the QFN package 10 to one or more of the bottom circuit contacts 12. In some specific embodiments, the specific topology of the top circuit contacts 13 may be substantially the same as the specific topology of the bottom circuit contacts 12. Accordingly, discussion of the specific topologies of the contacts 12 and 13 is meant to be illustrative and not limiting to various embodiments of the invention.

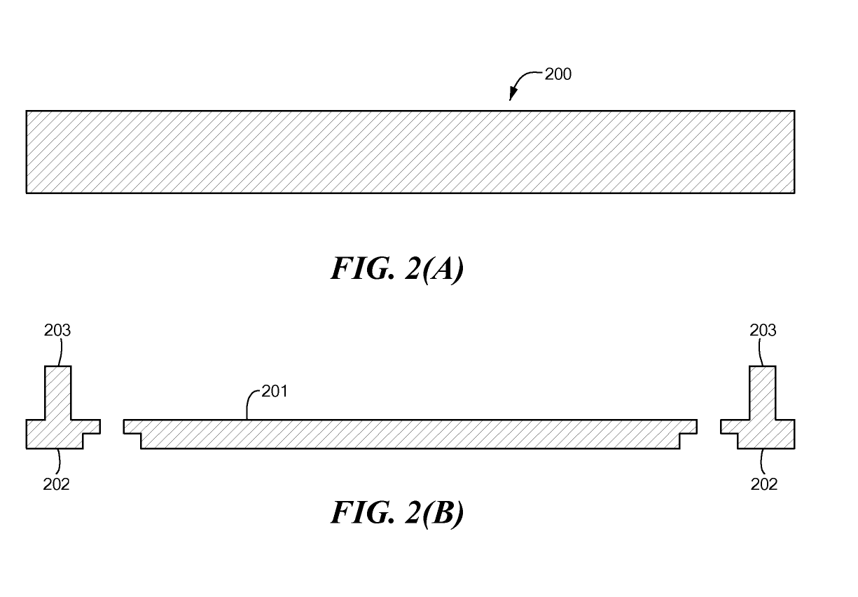

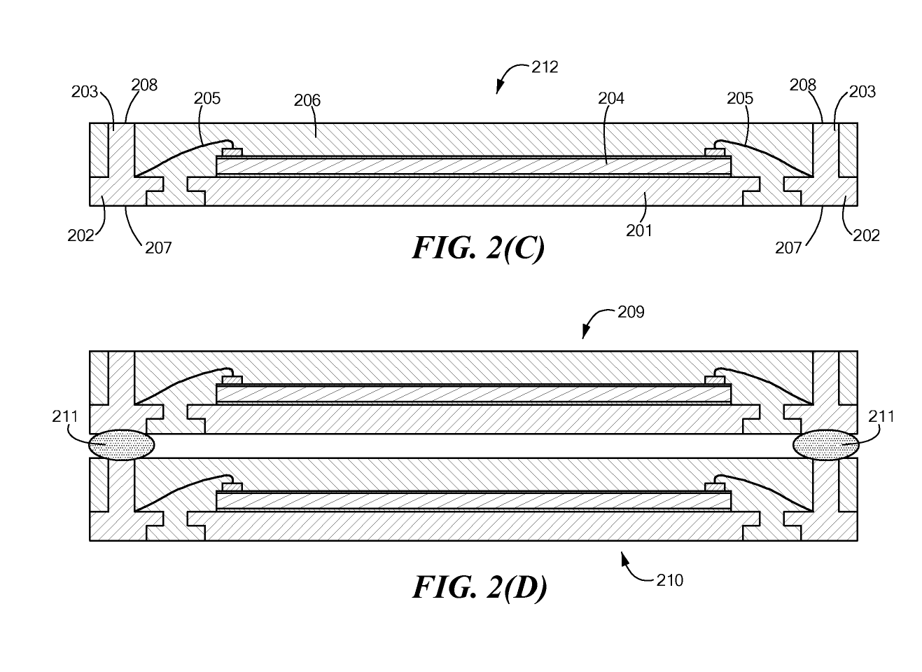

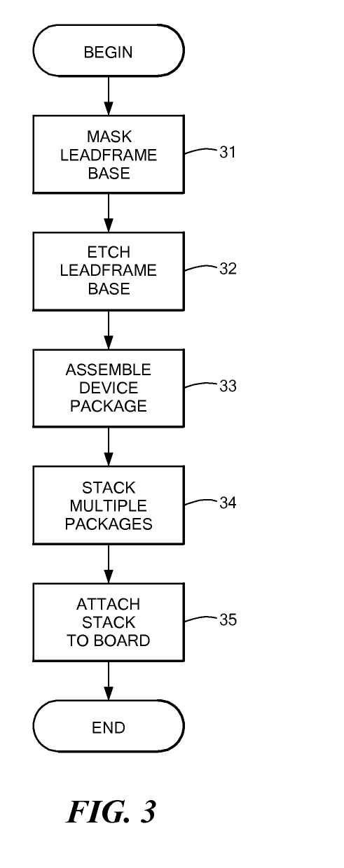

Some technologies such as Thin Array Plastic Package (TAPP) use a thin leadframe base, typically made of copper. This thin leadframe base can be selectively etched to produce interconnect pedestals according to an embodiment of the present invention. FIGS. 2A-D show various stages in assembling a stackable QFN-based package according to an embodiment, and FIG. 3 shows general functional steps in such a process. FIG. 2A shows an initial leadframe base 200 made of electrically conductive material such as copper. The initial leadframe base 200 is masked for etching in one of the manners known in the art, step 31. As shown in FIG. 2B, leadframe forming techniques such as etching are applied to the base 200, step 32, to create various portions of a device package including a die attachment pad 201 (also known as a die paddle) and package leads 202. By appropriate control of the etching process, an interconnect pedestal 203 is formed on the top of one or more of the leads 202. In some embodiments, the initial leadframe base is etched more than halfway through so that the height of the interconnect pedestals 203 is greater than the thickness of the remaining base material such as the die attachment pad 201.

A device package 212 is continued to be assembled in the usual way, step 33—a circuit die 204 is fixed to the die attachment pad 201. Then conductive wirebonds 205 are applied to electrically connect desired points on the die 204 to appropriate leads 202. The wirebonds 205 may be made of gold, silver, copper, or a conductive alloy. Next, encapsulation material 206 is molded over the entire structure as shown in FIG. 2C.

This leaves exposed for connection purposes bottom circuit contacts 207 on the bottom of the leads 202, and top circuit contacts 208 on the tops of the interconnect pedestals 203. The bottom circuit contacts 207 form a pattern for electrical connection to corresponding package circuit contacts of an underlying circuit structure. The top circuit contacts 208 also are arranged in a pattern for electrical connection to corresponding bottom circuit contacts of an overlying electronic package, as shown in FIG. 2D where a top package 209 is stacked over a bottom package 210. In some embodiments, the patterns of the top circuit contacts 208 and the bottom circuit contacts 207 may be different, while in other embodiments the patterns may be substantially similar. Conductive bridges 211 (e.g., solder, conductive adhesive, etc.) are created to physically and electrically connect the two packages, step 34. The resulting multi-package stack is then attached to the final assembly board, step 35. In some embodiments, the bottom package 210 may be attached to the final assembly board before having one or more other packages attached on top.

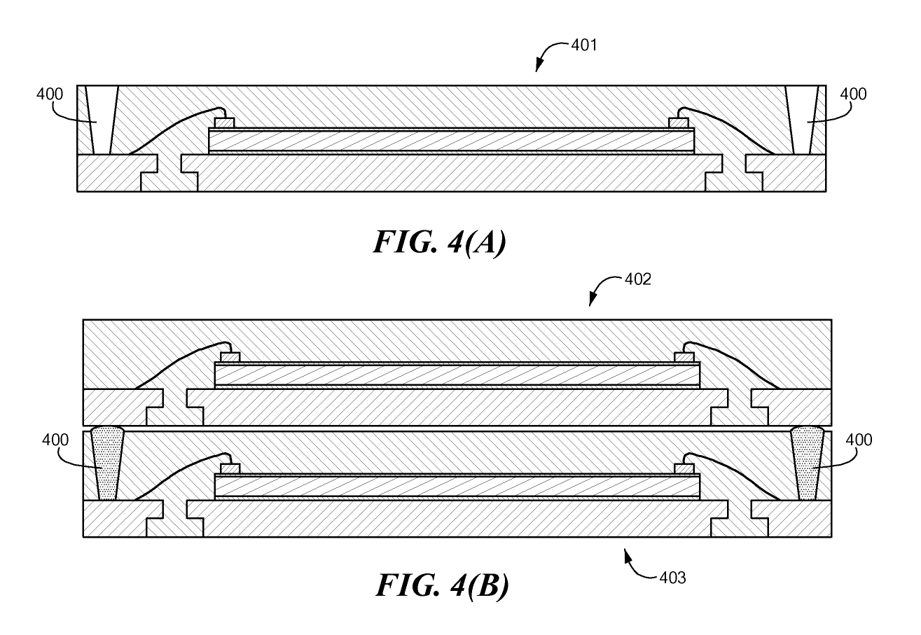

In addition or alternatively, as shown in FIG. 4, the top circuit contacts may be the tops of filled vias 400 in an assembled device package 401. In such case, the vias 400 may be fabricated using, for example without limitation, laser drilling, deep reactive ion etching (DRIE), potassium hydroxide (KOH) etching, or photo-assisted electro-chemical etching (PAECE). The vias 400 may be filled with a solidified flow of electrically conductive material and/or with electrically conductive pins to connect a bottom package 402 to a top package 403.

The components contained within the QFN package 10 may be conventional electronic devices such as one or more integrated circuits or application specific integrated circuits (ASIC); or convention electromechanical devices such as sensors, etc.; or Micro-Electromechanical Systems (MEMS) devices which integrate mechanical or other non-electronic functions with electrical functions.

Although the above discussion discloses various exemplary embodiments of the invention, it should be apparent that those skilled in the art can make various modifications and combinations of various discussed embodiments that will achieve some of the advantages of the invention without departing from the true scope of the invention.

What is claimed is:

1. An electronics package comprising:
a quad flat no lead (QFN) electronics package having top and bottom surfaces,
the bottom surface including a plurality of bottom circuit contacts for electrical connection to corresponding package contacts of an underlying circuit structure, and
the top surface including a plurality of top circuit contacts for electrical connection to corresponding bottom circuit contacts of an overlying electronics package.

2. A package according to claim 1, wherein the top circuit contacts are the tops of leadframe pedestals of a leadframe including the bottom circuit contacts.

3. A package according to claim 2, wherein the leadframe pedestals have a height greater than the thickness of the leadframe.

4. A package according to claim 1, wherein the top circuit contacts are the tops of filled vias in the package.

5. A package according to claim 4, wherein the vias are filled with a solidified flow of electrically conductive material.

6. A package according to claim 4, wherein the vias are filled with electrically conductive pins.

7. A package according to claim 1, wherein a set of the top circuit contacts are electrically connected to a set of the bottom circuit contacts.

8. A method of creating an electronics package, the method comprising:
fabricating a quad flat no lead (QFN) electronic package having top and bottom surfaces wherein:
i. the bottom surface includes a plurality of bottom circuit contacts for electrical connection to corresponding package contacts of an underlying circuit structure, and
ii. the top surface includes a plurality of top circuit contacts for electrical connection to corresponding bottom circuit contacts of an overlying electronic package.

9. A method according to claim 8, wherein the top circuit contacts are the tops of leadframe pedestals of a leadframe including the bottom circuit contacts.

10. A method according to claim 9, wherein the leadframe pedestals have a height greater than the thickness of the leadframe.

11. A method according to claim 8, wherein the top circuit contacts are the tops of filled vias in the package.

12. A method according to claim 11, wherein the vias are filled with a solidified flow of electrically conductive material.

13. A method according to claim 11, wherein the vias are filled with electrically conductive pins.

14. A method according to claim 8, wherein a set of the top circuit contacts are electrically connected to a set of the bottom circuit contacts.

15. An electronics package comprising:
a quad flat no lead (QFN) electronic package having top and bottom surfaces,
the bottom surface including a plurality of bottom connecting means for electrical connection to corresponding package connecting means of an underlying circuit structure, and
the top surface including a plurality of top connecting means for electrical connection to corresponding bottom connecting means of an overlying electronic package.

16. A package according to claim 15, wherein the top connecting means include the tops of leadframe pedestals of a leadframe including the bottom connecting means.

17. A package according to claim 16, wherein the leadframe pedestals have a height greater than the thickness of the leadframe.

18. A package according to claim 15, wherein the top connecting means include the tops of filled vias in the package.

19. A package according to claim 18, wherein the vias are filled with a solidified flow of electrically conductive material.

20. A package according to claim 18, wherein the vias are filled with electrically conductive pins.

21. A package according to claim 15, wherein a set of the top connecting means are electrically connected to a set of the bottom connecting means.
